(19) United States
(12) Patent Application Publication
(10) Pub. No.: US 2023/0405691 A1
(43) Pub. Date: Dec. 21, 2023

(54) TOOL

(71) Applicant: MAPAL Fabrik für Präzisionswerkzeuge Dr. Kress KG, Aalen (DE)

(72) Inventor: Ulrich KRENZER, Wolfertschwenden (DE)

(21) Appl. No.: 18/035,164

(22) PCT Filed: Nov. 2, 2021
(86) PCT No.: PCT/EP2021/080410

§ 371 Date: May 3, 2023

(30) Foreign Application Priority Data
Nov. 10, 2020 (DE) 10 2020 214 134.7

(51) Int. Cl. B23B 51/02

(52) U.S. Cl. CPC B23B 51/02

(57) ABSTRACT

The invention relates to a tool for the machining of bores. The tool includes a tool body with a centre axis and a tool end face. At least two secondary cutting edges are formed on the tool body; each secondary cutting edge of the at least two secondary cutting edges, starting from a cutting corner corresponding with the secondary cutting edge on the tool end face, extending in the direction of the centre axis towards a shaft end of the tool in a helical manner with a specific twist pitch. A support collar adjoins each of the secondary cutting edges at a distance, measured in the direction of the centre axis, of at least 0.18 times up to at most 0.28 times the specific twist pitch from the corresponding cutting corner, which support collar extends in the circumferential direction at least up to 1700 to the corresponding cutting corner.

The invention relates to a tool for the machining of bores.

Such a tool has a tool body with a centre axis and a tool end face, wherein at least two secondary cutting edges are formed on the tool body, wherein each secondary cutting edge of the at least two secondary cutting edges, starting from a cutting corner corresponding with the secondary cutting edge on the tool end face, extends in the direction of the centre axis towards a shaft end of the tool in a helical shape, that is helically, with a specific twist pitch. Such a tool can be designed, for example, as a drilling tool, in particular as a helical drill, but also as a reamer, or in another suitable manner. The aim of a bore manufacturing process is to produce a round, non-lapsing bore which has as little deviation as possible from an ideal cylindrical shape. This proves to be particularly difficult when circumstances exist that cause the tool to be displaced from the imaginary centre of the bore, especially because it is subjected to forces that are asymmetrical with respect to the centre axis. It is particularly difficult if the tool must drill through cavities such as transverse holes, or if it emerges from the workpiece on a surface that is inclined to the hole axis. Especially under these circumstances, large, unilaterally acting forces can occur that deflect the tool from the imaginary bore axis.

In principle, it is possible to equip such a tool with guide chamfers in the area of the secondary cutting edges, which have a stabilising effect against such a displacement. However, even guide chamfers can only prevent displacement to a limited extent. For example, twist drills typically comprise two guide chamfers that limit the side cutting edges laterally. These can well absorb transverse forces acting parallel to main cutting edges of the tool; however, a main force acting perpendicularly on the main cutting edges cannot be absorbed by the guide chamfers. Especially for drilling depths greater than 5 times the drill diameter, there are also twist drills that comprise a greater number of guide chamfers than the number of secondary cutting edges, for example four or even six guide chamfers. With such drills, an improved hole accuracy can be achieved; in particular, roundness and straightness of a hole can be improved by such additional guide chamfers. However, if the tool exits the bore on an inclined surface, even these additional guide chamfers cannot contribute to an improvement of the situation, since they lack the bore wall necessary for support due to the interruption of the cut on the inclined outer surface. On the contrary, the additional guide chamfers even prevent subsequent cutting edges from at least partially compensating for the displacement of the front cutting edge, since the guide chamfers continue to guide the drill in the bore that has already run. As a result, the lapse increases with each further revolution. The drill then begins to jam in the hole. There is very high friction on the guide chamfers and the bore wall, which causes higher torques and higher wear on the guide chamfers. Overloaded guide chamfers and cutting corners can ultimately lead to tool breakage.

It is therefore the objective of the invention to create a tool for the machining of bores, in which at least some of the aforementioned disadvantages are at least partially avoided, preferably eliminated.

The objective is solved by providing the present technical teaching, in particular the teaching of the independent claims as well as the embodiments disclosed in the dependent claims and the description.

The objective is solved in particular by further designing a tool for the chip-removing production of bores in such a way that a support collar adjoins each of the secondary cutting edges at a distance, measured in the direction of the centre axis, from the corresponding cutting corner of at least 0.18 times up to at most 0.28 times the specific twist pitch, which collar extends in the circumferential direction at least up to 170°, preferably at least up to 180°, to the corresponding cutting corner. In particular, this advantageously creates a guide which is axially set back from the tool end face and thus has improved and stabilising guide properties. In addition, the tool is supported by the support collar in a range of at least up to 170° to the corresponding cutting corner, so that in particular resulting forces, which are essentially defined by the main cutting force and possibly a passive force acting perpendicularly to this on the tool, can also be supported on the support collar. The axially recessed arrangement of the support collar is particularly advantageous because the support can thus lie at least partially outside the interrupted cut even when the tool exits at an angle, that is, it is effective in particular in the fully cylindrical, uninterrupted part of the bore and thus also supports the cutting edges of the tool in the phase of the interrupted cut. At the same time, however, this type of guide also allows the tool tip to spring back into the axis of rotation when a cutting edge comes out of engagement with the material being machined, and in particular before another cutting edge comes into engagement.

In a preferred embodiment, a bore is understood here to be a bore that is or will be made in the full material of a workpiece, that is, a solid bore. However, the production of bores is also understood to mean the completion of a bore. The tool can therefore be designed, on the one hand, to create a new bore from the solid material of the workpiece, or, on the other hand, to finish a bore that may have previously been created with another tool or in another way, for example to ream it to size.

A tool end face is understood to mean in particular a front of the tool body intended to face a workpiece to be machined. A shaft end is understood to mean in particular an end of the tool intended to face away from the workpiece to be machined, which end is opposite the tool front along the centre axis. In a preferred embodiment, the shaft end is adapted to be connected to a machine tool or an adapter or the like. In particular, the shaft end may be a clamping end or shaft of the tool. An “extension in the direction of the shaft end” means in particular that the element designated in this way extends in the direction of the shaft end; the element does not necessarily have to reach the shaft end, but can rather end at a distance from the shaft end.

The at least two secondary cutting edges are preferably formed on a circumference of the tool body, in particular on a circumferential surface of the tool body.

The cutting corners are preferably formed as intersections of a respective secondary cutting edge with a main cutting edge corresponding with the secondary cutting edge, which is formed on the tool face.

In particular, the support collar adjoins the corresponding secondary cutting edge in the circumferential direction, being arranged at the said distance from the cutting corner measured in the direction of the centre axis. Preferably, the support collar directly adjoins the corresponding secondary cutting edge in the circumferential direction.

The support collar is in particular a support surface, which in particular has a certain extension on the one hand in the direction of the centre axis and on the other hand in the circumferential direction. In particular, the support collar provides a widened guide area for the tool.

The support collar preferably has a position in the radial direction that corresponds to the radial position of the secondary cutting edge at the location of the support collar—in the direction of the centre axis. This allows the tool to be supported in the area of the support collar on a wall of the machined workpiece. In particular, the support collar is not a surface area set back relative to the radial position of the secondary cutting edge. In order to reduce friction in the bore, the tool has a certain taper starting from a flight circle defined by the cutting corners along the secondary cutting edges in the direction of the centre axis towards the end of the shaft, typically from about 0.2 mm to 0.4 mm over a length of 100 mm—along the centre axis. The radius in the area of the support collar preferably has the value defined by this specific taper, that is, it is only slightly smaller than the radius of the flight circle.

In a preferred embodiment, it is possible that the support collar is cylindrical, that is, it does not itself have a taper. According to another preferred embodiment, the support collar has a slight taper—in the form of a taper—towards the end of the shaft, which preferably corresponds at most to the aforementioned taper or, in a particularly preferred embodiment, is smaller than the aforementioned taper, in particular smaller than or at most equal to 0.2 mm per 100 mm length.

If the support collar has such a design, it advantageously provides such efficient support for the tool that the tool can have a greater taper outside the support collar than corresponds to the conventional values mentioned above. Thus, the friction of the tool in a bore outside the support collar is advantageously reduced compared to a conventional tool.

In particular, the tool is preferably manufactured by shaping a tool blank created by cylindrical grinding into the tool by means of geometry grinding, whereby in particular the cutting edge geometries are formed on the tool blank by geometry grinding. Flutes as well as recesses, in particular in the circumferential direction behind guide chamfers of the tool, are also preferably created by geometry grinding, whereby material is removed from the tool blank during geometry grinding. The support collar is preferably a surface or geometry that is left standing—i.e. not changed—during geometry grinding, i.e. in particular a surface section or geometry that is produced by cylindrical grinding and already exists on the tool blank.

An axial direction denotes here and in the following a direction along the centre axis. A radial direction is perpendicular to the axial direction and thus to the centre axis; a circumferential direction embraces the centre axis and thus the axial direction concentrically.

According to a preferred embodiment, it is provided that the supporting collar starts at a distance of at least 0.18 times up to at most 0.28 times, preferably at least 0.22 times up to at most 0.25 times the specific twist pitch from the corresponding cutting corner. Thus, there is no support collar in areas further towards the tool end face.

In particular, the specific twist pitch is given in units of length per revolution, so that a simple factor applied to it in turn gives a length.

According to an alternative definition, the distance of the support collar from the cutting corner in the direction of the centre axis is preferably from at least the diameter of the flight circle—hereinafter abbreviated to flight circle diameter—to at most 1.8 times the flight circle diameter, preferably from at least the flight circle diameter to at most 1.5 times the flight circle diameter, preferably from at least 1.2 times the flight circle diameter to at most 1.4 times the flight circle diameter.

According to a preferred embodiment, it is provided that the support collar extends in the direction of the centre axis, that is, in the axial direction, from a first location on the centre axis to a second location on the centre axis, wherein the first location of the centre axis is arranged at a first distance from the cutting corner which corresponds to 0.18 times, preferably 0.22 times, the specific twist pitch, preferably 0.22 times the specific twist pitch, the second location being arranged at a second distance from the cutting corner which is at least 0.25 times, preferably at least 0.28 times, preferably at least 0.3 times, preferably at least 0.35 times the specific twist pitch. Alternatively, the first distance of the first location from the cutting corner corresponds to at least the flight circle diameter, preferably to 1.2 times the flight circle diameter, whereby the second distance of the second location from the cutting corner preferably corresponds to at least 1.4 times the flight circle diameter, preferably to at least 1.5 times the flight circle diameter, preferably to at least 1.8 times the flight circle diameter, preferably to at least 1.9 times the flight circle diameter. The support collar can also—as explained in particular in more detail below—extend in the direction of the centre axis at least substantially up to an end of chip flutes of the tool facing the shaft end, the second location then being located at the end of the chip flutes facing the shaft end.

The values mentioned here in connection with the distances of the first location and the second location as well as previously in connection with the distances of the support collar from the cutting corner and related to the flight circle diameter apply in a preferred embodiment in particular to a tool that has a helix angle of the secondary cutting edges of 30°.

According to a further development of the invention, it is provided that the support collar adjoins the corresponding secondary cutting edge at a distance, measured in the direction of the centre axis, of at least 0.22 times up to at most 0.25 times the specific twist pitch from the corresponding cutting corner. In this distance range, the advantages already explained above arise in a special way.

In particular, the supporting collar starts at a starting angle of at least 65°, preferably of at least 80°, up to at most 120°, preferably up to at most 100°, from the corresponding cutting corner—measured in plan view of the tool end face and against an intended direction of rotation of the tool relative to a machined workpiece. Starting from this starting angle, the supporting collar then preferably extends to an end angle of at least 170°, preferably of at least 180°, preferably of at least 185°, preferably—if the supporting collar does not revolve, if necessary several times—to at most 240°, preferably to at most 190°, which is again measured in the manner described above. In this way in particular, it is ensured that a resulting force acting in particular on a main cutting edge of the tool, which is preferably composed vectorially of on the one hand the main cutting force and on the other hand a radial passive force, is supported on a side diametrically opposite to its point of application of force, but at an axial distance from the tool end face.

According to a further embodiment of the invention, it is provided that the supporting collar, measured in the circumferential direction from the corresponding cutting corner, starts at a starting angle of at least 65°, preferably of at least 80°, up to at most 120°, preferably up to at most 100°. Alternatively or additionally, the supporting collar, measured in the circumferential direction from the corresponding cutting corner, ends at an end angle of at least 170°, preferably of at least 180°, preferably—if the supporting collar does not rotate, possibly several times—up to at most 240°, preferably up to at most 190°. In these angle ranges, the advantages already mentioned are realised in a special way. In this case, the angles are measured from the cutting corner, again looking in the direction of the centre axis towards the tool end face and against the intended direction of rotation of the tool relative to a machined workpiece.

According to a further embodiment of the invention, it is provided that a guide chamfer corresponds to each of the secondary cutting edges, which extends from the corresponding cutting corner to the corresponding support collar. In this way, the tool combines the advantages of guide chamfers with the advantages of the support collar in a particularly favourable manner. In a preferred embodiment, however, the guide chamfers can be very narrow, in particular narrower than in conventional tools, since the support collar is essentially responsible for supporting the tool. This advantageously reduces the friction of the tool in the bore and thus also its wear and heating. At the same time, this also reduces the risk of tool breakage, especially when producing deep bores.

In particular, the guide chamfer preferably ends in the direction of the centre axis where the support collar begins.

According to a preferred embodiment, the tool has as many guide chamfers as secondary cutting edges. In particular, each secondary cutting edge is uniquely corresponding to a guide chamfer—and vice versa. In particular, the tool advantageously has no additional guide chamfers, so that its friction in the machined bore is small while still providing excellent support.

According to a further embodiment of the invention, it is provided that the support collar—in particular each support collar of the tool—has a length measured in the direction of the centre axis which is at least 0.2 times, preferably up to at most 1 times, the diameter of the flight circle.

Particularly in this length range of the support collar, a very good support is obtained with low friction of the tool at the same time.

Preferably, the support collar has a length—in particular measured along the centre axis—which is at least 20%, preferably at least 50%, preferably—if the support collar does not extend to the end of the chip flutes facing the shaft end—up to at most 100%, preferably up to at most 60%, preferably 50% of the flight circle diameter.

According to a further embodiment of the invention, it is provided that each secondary cutting edge of the at least two secondary cutting edges is corresponding with a chip flute extending helically from the tool face in the direction of the centre axis towards the end of the shank. In this way, chips removed in the bore can be efficiently transported away.

According to a further embodiment of the invention, it is provided that the support collar extends in the direction of the centre axis at least substantially up to an end of the chip flutes facing the shaft end. In this embodiment, the support collar has a particularly long length, preferably starting at the axial distance from the cutting corner defined above and then extending—also helically—from this distance along the corresponding secondary cutting edge and thus at the same time along a corresponding chip flute essentially to its end facing the shaft end. Preferably, the support collar extends to the end of the corresponding chip flute facing the shaft end. In this way, a particularly comprehensive and stable guidance of the tool in a bore is achieved, especially at large axial distances from the cutting edge. The support is improved, especially in comparison to a shorter support collar, but at the same time the friction in the bore is increased.

According to a further embodiment of the invention, it is provided that at least one lubricating groove is formed in the support collar. The lubricating groove serves in particular to guide coolant and/or lubricant and thus in particular to cool and lubricate the tool during the machining process. Preferably, the tool has an internal coolant/lubricant supply, in particular at least one coolant/lubricant supply channel, which passes through the tool body from the shaft end to the tool end face and preferably opens into an outlet bore in the tool end face, where the coolant/lubricant emerges from the tool body. This is then deflected, in particular in a bore bottom of the machined bore, and flows along the outer circumference of the tool body back towards the shaft end. In particular, it enters the lubricating groove formed in the support collar. The lubricating groove can also advantageously act at the same time as a kind of hydraulic pocket in which a hydraulic pressure stabilising the tool run and the tool position in the bore is built up—in particular dynamically on the one hand by the rotational movement of the tool relative to the workpiece and on the other hand by the flow of the lubricant.

According to a preferred embodiment, the lubricating groove preferably extends in the circumferential direction without having a lubricating groove twist pitch. In this case, the lubricating groove extends concentrically around the centre axis, in particular in an annular shape.

According to another preferred embodiment, it is provided that the at least one lubricating groove extends in the support collar with a lubricating groove twist pitch different from the specific twist pitch. In particular, in this way, an efficient hydraulic pocket for stabilising the tool can be provided. This is particularly true if, in a particularly preferred embodiment, the at least one lubricating groove extends with a lubricating groove twist pitch opposite to the specific twist pitch. Due to the rotational movement of the tool relative to the workpiece, a lubricant pressure is then built up in the lubricating groove, which stabilises and guides the tool particularly efficiently in the bore.

According to yet another embodiment, it is preferably provided that the at least one lubricating groove extends in the support collar with a lubricating groove twist pitch identical to the specific twist pitch. In this way, the lubricant can be guided particularly efficiently in the lubricating groove and transported in the direction of the shaft end, so that efficient heat dissipation is ensured.

According to a further development of the invention, it is provided that the guide chamfers have a width—in particular measured orthogonally to the centre axis—which is at most 5%, preferably at most 3% of the flight circle diameter. Thus, the guide chamfers are advantageously very narrow, in particular as so-called visible chamfers, and contribute only to a small extent to friction of the tool in the bore.

According to a further embodiment of the invention, it is provided that the support collar is divided into a plurality of support collar areas in the circumferential direction by at least one lubricating groove extending in the support collar. In this case, a sum of the widths—in particular measured orthogonally to the centre axis—of the support collar regions of the support collar is at least twice as large, preferably three times as large, as the width—preferably also measured orthogonally to the centre axis—of the guide chamfer corresponding with the support collar. In this way, the support collar can provide good support for the tool despite the interruption by the at least one lubricating groove.

According to a further embodiment of the invention, it is provided that the tool has exactly two secondary cutting edges. Alternatively, it is preferred that the tool has exactly three secondary cutting edges. In particular, the tool can be designed as a two-blade cutter or as a three-blade cutter.

According to a further embodiment of the invention, the tool is designed as a drilling tool, in particular as a twist drill. In this case, the advantages already mentioned are realised in a very special way. In particular, these advantages are realised when the tool is designed as a deep drill, in particular for drilling depths greater than 5 times the flight circle diameter.

According to a further embodiment of the invention, it is finally provided that each secondary cutting edge of the at least two secondary cutting edges is corresponding with a main cutting edge at the tool end, wherein the main cutting edge merges into the corresponding secondary cutting edge at the respective cutting corner. In particular, the main cutting edge intersects the secondary cutting edge at the respective cutting corner. In particular, the tool preferably has exactly two main cutting edges or exactly three main cutting edges, with each main cutting edge being corresponding with exactly one secondary cutting edge.

The invention is explained in more detail below with reference to the drawing. Thereby show:

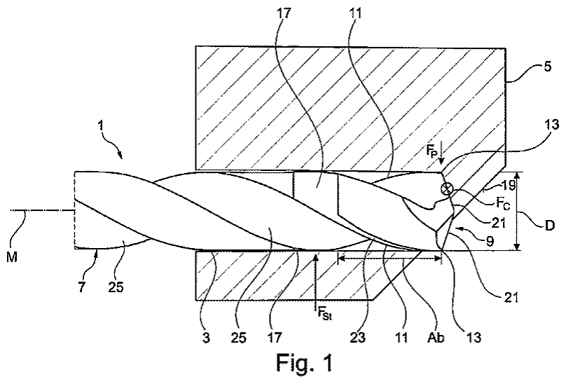

FIG. 1 a schematic representation of a first embodiment of a tool in use for the machining of a bore;

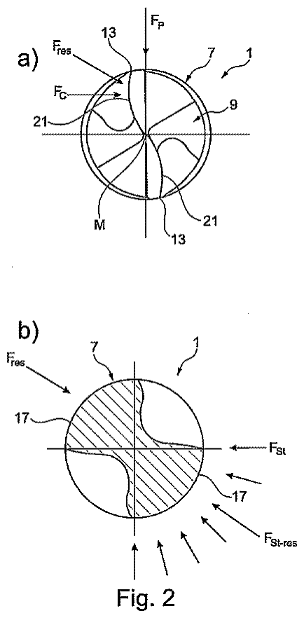

FIG. 2 the principle of operation of the tool;

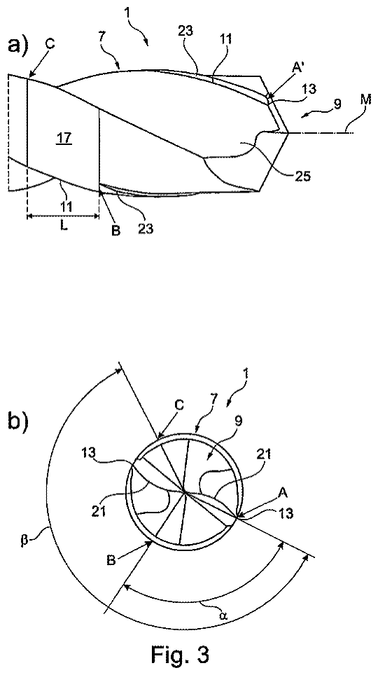

FIG. 3 another illustration of the tool according to FIG. 1;

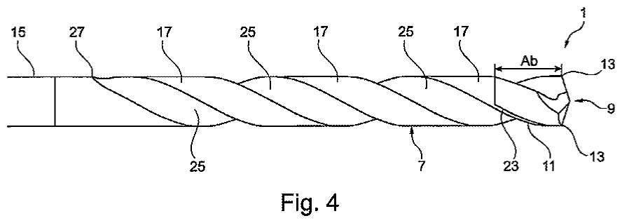

FIG. 4 an illustration of a second embodiment of the tool;

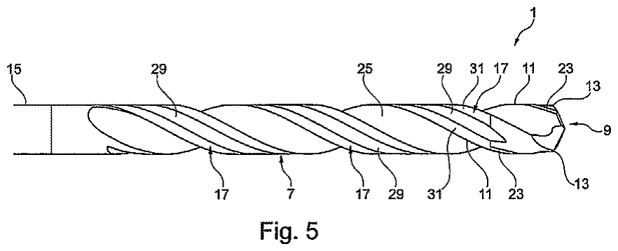

FIG. 5 an illustration of a third embodiment of the tool;

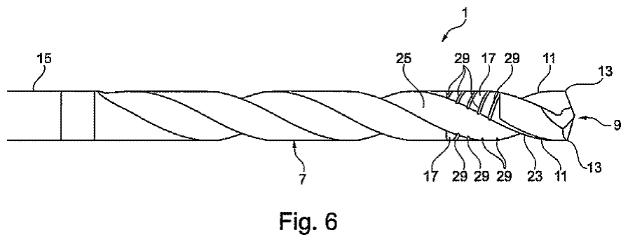

FIG. 6 an illustration of a fourth embodiment of the tool, and

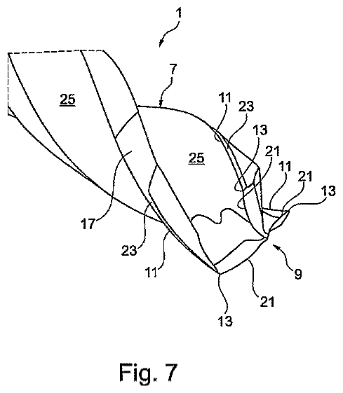

FIG. 7 an illustration of a fifth embodiment of the tool.

FIG. 1 shows a representation of a first embodiment of a tool 1 for machining a bore 3 in a workpiece 5. The tool 1 comprises a tool body 7 with a centre axis M and a tool end face 9. Exactly two secondary cutting edges 11 are formed on the tool body 7, in particular on a circumference thereof, in the first embodiment example shown here. The secondary cutting edges 11 and all the elements further associated with them are identically formed in the tool 1 shown here, so that in the following, for reasons of conciseness, only one of the secondary cutting edges 11 and the associated elements will be dealt with in more detail.

The secondary cutting edges 11 extend from a cutting corner 13 corresponding with the respective secondary cutting edge 11 on the tool end face 9 in the direction of the centre axis M towards a shaft end 15 of the tool 1, shown in particular in FIG. 4, in a helical manner with a specific twist pitch. The specific twist pitch is indicated in particular in the unit “length in the direction of the centre axis per revolution of the helical secondary cutting edges 11”. Adjacent to each of the secondary cutting edges 11—in the circumferential direction—at a distance Ab, measured in the direction of the centre axis M, from the associated cutting corner 13 is a support collar 17 which extends in the circumferential direction at least up to an angle of 170°, preferably 180°, measured from the corresponding cutting corner 13.

The distance Ab is from at least 0.18 times to at most 0.28 times the specific twist pitch. In particular, the support collar 17 starts at this distance Ab from the cutting corner 13.

Alternatively, the distance of the support collar 17 from the cutting corner 13 is preferably from at least once a flight circle diameter D of the tool 1, which is defined by the cutting corners 13, to at most 1.8 times the flight circle diameter D, preferably from at least once the flight circle diameter D to at most 1.5 times the flight circle diameter D, preferably from at least 1.2 times the flight circle diameter D to at most 1.4 times the flight circle diameter D. This applies in particular to a tool 1 whose secondary cutting edges 11 have a helix angle of 30°.

Preferably, the distance Ab is from at least 0.22 times to at most 0.25 times the specific twist pitch.

The support collar 17, which is set back axially from the cutting corner 13, advantageously creates a guide that guides the tool 1 in a particularly stable manner in the bore 3. This applies in particular to deep bores, especially with a bore depth of more than 5 times the flight circle diameter D. This applies in particular—as shown schematically in FIG. 1—to the machining of a bore 3 in which the tool 1 emerges from the workpiece 5 at an inclined surface 19. As can be seen in FIG. 1, the tool 1 loses its guidance in the area of a cutting corner 13 and thus at the same time a secondary cutting edge 11—shown here at the lower cutting corner 13 and the corresponding secondary cutting edge 11—so that it is loaded on one side and thus deflected from its axis of rotation. This is now effectively counteracted by the support collar 17 which, due to its axial back offset, is supported in an area of the bore 3 where material is still available for support even on the side where there is no more material in the area of the bore exit. Accordingly, a lapse, in particular a jamming of the tool 1 in the bore 3 is avoided; the bore 3 obtains an excellent roundness and straightness, and the danger of tool breakage is drastically reduced for the tool 1.

Each secondary cutting edge 11 is corresponding with a main cutting edge 21 at the tool end face 9, which merges into the assigned secondary cutting edge 11 at the respective cutting corner 13.

In particular, forces relevant to the machining of the workpiece 5 are shown here, especially a main cutting force Fc, which is perpendicular to the image plane in the direction of view of the observer and acts on one of the main cutting edges 21, a passive force Fp acting in the radial direction, as well as a supporting force FSt acting on the supporting collar 17. The corresponding functioning of the tool 1 and the significance of these forces are explained in more detail in connection with FIG. 2.

Each secondary cutting edge 11 is corresponding with a guide chamfer 23 which extends from the corresponding cutting corner 13 to the corresponding support collar 17. In particular, the guide chamfer 23 ends in the direction of the centre axis M where the support collar 17 begins.

Preferably, the tool 1 has as many guide chamfers 23 as it has secondary cutting edges 11.

Each secondary cutting edge 11 is corresponding with a chip flute 25 extending helically from the tool end face 9 in the direction of the centre axis M towards the shaft end 15.

The guide chamfers 23 each preferably comprise a width that is at most 5%, preferably at most 3% of the flight circle diameter D.

In a preferred embodiment—as shown here—the tool 1 is designed as a drilling tool, in particular as a twist drill. However, it is also possible that the tool 1 is designed, for example, as a reamer or in another suitable way.

FIG. 2 shows a schematic representation of the operation of the tool 1 in connection with the machining of the bore 3 shown in FIG. 1 when the tool 1 exits in the region of the inclined surface 19.

Identical and functionally identical elements are provided with the same reference signs in all figures, so that reference is made to the previous description in each case.

At a) a top view of the tool end face 9 is shown, whereby here again the forces acting on the main cutting edge 21, which is still in engagement with the material of the workpiece 5, are shown schematically. The main cutting force Fc acts perpendicularly on the main cutting edge 21, the passive force Fp acts radially to the centre axis M, and a resulting force Fres results from this by vectorial addition—whereby the arrows shown are not drawn to scale. There is no longer any force acting on the other main cutting edge 21, which has already emerged from the inclined surface 19. Therefore, the resulting force Fres tries to push tool 1 away from the axis of rotation.

At b) a cross-sectional view through the tool 1 at the axial height of the support collar 17 is shown. It is clear that the support collar 17 provides support for the tool 1 in the bore 3 diametrically opposite the resulting force Fres, which is represented here by a resulting support force FSt-res. Also shown is a supporting force FSt acting diametrically opposite the main cutting force Fc. In the axially recessed area of the supporting collar 17, material of the workpiece 5 is still present on all sides in the bore 3, against which the tool 1 can effectively support itself with the supporting collar 17. This prevents the tool from being pushed away from the axis of rotation and thus prevents the bore 3 from lapsing. As a result, the support collar 17 has the advantage that the support of the tool 1 in the bore 3 is shifted axially backwards away from the area of the cutting corners 13 in the direction of the shaft end 15, which has a positive effect overall on the support and guidance of the tool 1, whereby particularly advantageous effects are achieved, however, in the case of deep bores and—as specifically shown here—in the case of an oblique bore exit.

FIG. 3 shows a further representation of the first embodiment of the tool 1 according to FIG. 1. Here, at a), a representation from the side is again reproduced, with certain points being highlighted: At A′, a point which is offset by 1800 about the central axis from the point A shown in FIG. 3b), the point A being associated with the cutting corner 13, which in turn is corresponding with the support collar 17 visible to the viewer in FIG. 3a); at B, a point at which the support collar 17 begins in the circumferential direction; and at C, a point at which the support collar 17 ends in the circumferential direction. In a), point A′, which is analogous to point A, is only shown because point A is hidden from the viewer in the representation according to a).

Also shown is a length L that the support collar 17 comprises in the direction of the centre axis M.

The length L is preferably from at least 0.2 times, preferably 0.5 times the flight circle diameter D, preferably in particular up to the single value of the flight circle diameter D.

At b) again a top view of the tool end face 9 is shown, where again the points A, B and C defined above are drawn.

The support collar 17 extends in the circumferential direction—measured from the corresponding cutting corner 13, that is, from point A—preferably over an angular range starting at at least 65°, preferably at least 80°, and ending at at least 170°, preferably at most 240°. This means that point B measured from point A is at least at 65°, preferably at least at 80°, whereby point C measured from point A is at least at 170°, preferably at most at 240°, whereby all angle indications refer to a full circle with 360°.

In particular, the support collar 17, measured in the circumferential direction from the corresponding cutting corner 13, preferably starts at an angle of at least 65°, preferably from at least 800 to at most 120°. The point B is thus in particular measured from the point A at an angle α which is from at least 650 to at most 120°.

Alternatively or additionally, the support collar 17 ends at an angle of at least 1700 to at most 2400 measured in the circumferential direction from the corresponding cutting corner 13; the point C is therefore at an angle β measured from the point A, in particular, of at least 1700 to at most 240°.

FIG. 4 shows a representation of a second embodiment of the tool 1. Here, the supporting collar 17—starting from, i.e. beginning at the distance Ab—measured from the corresponding cutting corner 13, extends in the direction of the centre axis M at least substantially up to an end 27 of the chip flutes 25 facing the shaft end 15, preferably up to the end 27.

FIG. 5 shows a representation of a third embodiment of the tool 1, wherein at least one lubricating groove 29, in particular exactly one lubricating groove 29, is formed in the support collar 17 here. Here, the lubricating groove 29 extends along the corresponding secondary cutting edge 11 with a lubricating groove twist pitch which is identical to the specific twist pitch of the secondary cutting edge 11.

FIG. 6 shows a representation of a fourth embodiment of the tool 1, wherein here a plurality of lubricating grooves 29 are formed in the support collar 17. These lubricating grooves 29 extend with a lubricating groove twist pitch different from the specific twist pitch of the secondary cutting edge 11, here in particular opposite to this specific twist pitch. In this way, hydraulic pockets can advantageously be provided in the form of the lubricating grooves 29, in which pressurised or flowing coolant/lubricant helps to stabilise the tool 1 in the bore 3.

It is also clear from the illustrations of FIGS. 5 and 6 that the support collar 17 can be divided in the circumferential direction by at least one lubricating groove 29 into a plurality of support collar regions 31, in the simpler case of FIG. 5 into two support collar regions 31. A sum of the widths of the support collar regions 31 of the support collar 17 is thereby preferably at least twice as large, preferably three times as large, as the width of the guide chamfer 23 associated with the support collar 17.

In a manner not shown here, it is also possible for the lubricating groove 29 to extend in the circumferential direction without a lubricating groove twist pitch.

Finally, FIG. 7 shows a representation of a fifth embodiment of the tool 1, which has exactly three secondary cutting edges 11 and correspondingly also exactly three main cutting edges 21 corresponding with each of these secondary cutting edges 11. This tool 1 is also designed as a drilling tool, in particular as a twist drill, here in particular as a three-flute cutter.

1. Tool for the machining of bores, comprising:
a tool body with a centre axis and a tool end face, wherein
at least two secondary cutting edges are formed on the tool body, each secondary cutting edge of the at least two secondary cutting edges, starting from a cutting corner corresponding with the secondary cutting edge on the tool end face, extending in the direction of the centre axis towards a shaft end of the tool in a helical manner with a specific twist pitch, wherein
a support collar adjoins each of the secondary cutting edges at a distance, measured in the direction of the centre axis, of at least 0.18 times up to at most 0.28 times the specific twist pitch from the corresponding cutting corner, which support collar extends in the circumferential direction at least up to 1700 to the corresponding cutting corner.

2. Tool according to claim 1, wherein the supporting collar adjoins the corresponding secondary cutting edge at a distance, measured in the direction of the centre axis, of at least 0.22 times to at most 0.25 times the specific twist pitch from the corresponding cutting corner.

3. Tool according to claim 1, wherein the supporting collar starts at an angle of at least 650 to at most 1200 measured in the circumferential direction from the corresponding cutting corner, and/or ends at an angle of at least 1700 to at most 240°.

4. Tool according to claim 1, wherein each of the secondary cutting edges is corresponding with a guide chamfer, which extends from the corresponding cutting corner to the corresponding support collar.

5. Tool according to claim 1, wherein the support collar comprises a length, measured in the direction of the centre axis, which is at least 0.2 times, preferably up to at most 1 times, the diameter of a flight circle of the tool defined by the cutting corners.

6. Tool according to claim 1, wherein each secondary cutting edge of the at least two secondary cutting edges is corresponding with a chip flute extending helically from the tool end face in the direction of the centre axis towards the shaft end.

7. Tool according to claim 1, wherein the support collar extends in the direction of the centre axis at least substantially up to an end of the chip flutes facing the shaft end.

8. Tool according to claim 1, wherein at least one lubricating groove is formed in the supporting collar, wherein the at least one lubricating groove extends
in circumferential direction without lubricating groove twist pitch, or
with a lubricating groove twist pitch different from the specific twist pitch, in particular opposite to the specific twist pitch, or
with lubricating groove twist pitch identical to the specific twist pitch.

9. Tool according to claim 1, wherein the guide chamfers comprise a width which is at most 5%, preferably at most 3%, of the diameter of the flight circle defined by the cutting corners.

10. Tool according to claim 1, wherein the support collar is divided in the circumferential direction by at least one lubricating groove into a plurality of support collar regions, wherein a sum of the widths of the support collar regions of the support collar is at least twice as large, preferably three times as large, as the width of the guide chamfer corresponding with the support collar.

11. Tool according to claim 1, wherein the tool has exactly two secondary cutting edges or exactly three secondary cutting edges.

12. Tool according to claim 1, wherein the tool is designed as a drilling tool, in particular as a twist drill.

13. Tool according to claim 1, wherein a main cutting edge is corresponding with each secondary cutting edge of the at least two secondary cutting edges on the tool end face, wherein the main cutting edge merges into the associated secondary cutting edge at the respective cutting corner.
